(19) United States
(12) Patent Application Publication
(10) Pub. No.: US 2015/0128388 A1
(43) Pub. Date: May 14, 2015

(54) BINDING APPARATUS, METHOD AND SYSTEM

(71) Applicant: Cory Mastbeth, Carlstadt, NJ (US)

(72) Inventor: Cory Mastbeth, Carlstadt, NJ (US)

(21) Appl. No.: 14/186,569

(22) Filed: Feb. 21, 2014

Related U.S. Application Data
(60) Provisional application No. 61/902,761, filed on Nov. 11, 2013.
(60) Provisional application No. 61/935,306, filed on Feb. 3, 2014.

(51) Int. Cl. B60P 7/08; B25B 25/00

(52) U.S. Cl. CPC B60P 7/083; B25B 25/00
USPC 24/68 CD; 29/428

(57) ABSTRACT

A ratchet machine includes a receiving member that is arranged and configured to receive a distal end of a removable actuation handle. The distal end fits within an aperture of the receiving member. The aperture includes a supporting surface region. The supporting surface region fully supports a mechanical interaction between the ratchet machine and the removable actuation handle.

The present application claims the benefit of U.S. provisional patent application No. 61/902,761 filed on Nov. 11, 2013; U.S. provisional patent application No. 61/902,627 filed on Nov. 11, 2013; and U.S. provisional patent application No. 61/933,306 filed on Feb. 3, 2014; the disclosures of all of which are herewith incorporated by reference in their entireties.

### FIELD OF THE INVENTION

The present invention relates to systems methods and apparatus for coupling equipment and more particularly to systems methods and apparatus for coupling equipment in confined spaces.

### BACKGROUND

Ratchet machines are used extensively in the tensioning of generally flexible longitudinal members such as straps, chains and cables for coupling apparatus against various mechanical loads. For example, in the binding of freight to and within vehicles and in the towing of one vehicle by another, it is often necessary to secure one member to another using tensioned members.

Ratchet machines are beneficial in such applications because of their relative simplicity, their ready adaptability to manual actuation, and their ability, when properly configured, to support high loads with apparatus of relatively light weight and small size. Notwithstanding the long history of such uses, however, there remain significant improvements to be made in the technology, as evidenced by the following disclosure.

### SUMMARY

Having examined and understood a range of previously available devices, the inventor hereof has developed a new and important understanding of the problems associated with the prior art and, out of this novel understanding, has developed new and useful solutions and improved devices, including solutions and devices yielding surprising and beneficial results. The (at least one) invention encompassing these new and useful solutions and improved devices is described below in its various aspects with reference to several exemplary embodiments including a preferred embodiment.

The following description is provided to enable any person skilled in the art to make and use the disclosed inventions and sets forth the best modes presently contemplated by the inventor of carrying out his inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the substance disclosed. These and other advantages and features of the invention will be more readily understood in relation to the following detailed description of the invention, which is provided in conjunction with the accompanying drawings.

It should be noted that, while the various figures show respective aspects of the invention, no one figure is intended to show the entire invention. Rather, the figures together illustrate the invention in its various aspects and principles. As such, it should not be presumed that any particular figure is exclusively related to a discrete aspect or species of the invention. To the contrary, one of skill in the art would appreciate that the figures taken together reflect various embodiments exemplifying the invention.

Correspondingly, references throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### BRIEF DESCRIPTION OF THE DRAWINGS

FIG. 1 shows, in cutaway schematic form, an arrangement for towing a first vehicle with a second vehicle incorporating aspects of the invention;

FIG. 2 shows, in perspective view, a portion of an apparatus useful in towing a vehicle, but having certain limitations;

FIG. 3a shows, in side view, a portion of an apparatus useful in towing a vehicle, but having certain limitations;

FIG. 3b shows, in top view, a portion of an apparatus useful in towing a vehicle, but having certain limitations;

FIG. 4a shows, in side view, certain aspects of apparatus useful in towing a vehicle, according to principles of the invention;

FIG. 4b shows, in top view, certain aspects of apparatus useful in towing a vehicle, according to principles of the invention;

FIGS. 5a, 5b and 5c show certain features of a receiving member for an apparatus useful in towing a vehicle according to principles of the invention;

FIG. 6 shows certain features of an apparatus useful in towing a vehicle according to principles of the invention;

FIG. 7 shows still further aspects of an apparatus useful in towing a vehicle according to principles of the invention;

FIGS. 8a and 8b illustrate yet further aspects of an apparatus useful in towing a vehicle according to principles of the invention;

FIG. 9 illustrates certain features and methods of applying an apparatus useful in towing a vehicle, according to principles of the invention;

FIG. 10 illustrates certain further features and methods of applying an apparatus useful in towing a vehicle, according to principles of the invention;

FIG. 11 illustrates in additional detail, certain aspects of an apparatus useful in towing a vehicle according to principles of the invention;

FIG. 12 shows further aspects of apparatus useful in towing a vehicle according to principles of the invention;

FIG. 13 shows yet additional details and aspects of an apparatus useful in towing a vehicle according to principles of the invention;

FIG. 14A shows further aspects of an embodiment of the invention including certain reinforcing features;

FIG. 14B shows in additional detail further reinforcing features for apparatus prepared according to principles of the invention;

FIG. 14C shows in some detail still further reinforcing features for apparatus prepared according to principles of the invention;

FIG. 15 shows further aspects of an embodiment of the invention including certain further reinforcing features; and

FIG. 16 shows further aspects of an embodiment of the invention including still further reinforcing features.

### DETAILED DESCRIPTION

As noted above, the inventor has examined and understood a range of previously available devices. Out of this examination, along with analysis and creative thought, the inventor has developed a new and important understanding of the problems associated with the prior art and consequently, has developed new and useful solutions and improved devices; these solutions and devices yielding surprising and beneficial results. The (at least one) invention encompassing these new and useful solutions and improved devices is described herewith in its various aspects with reference to several exemplary embodiments including a preferred embodiment.

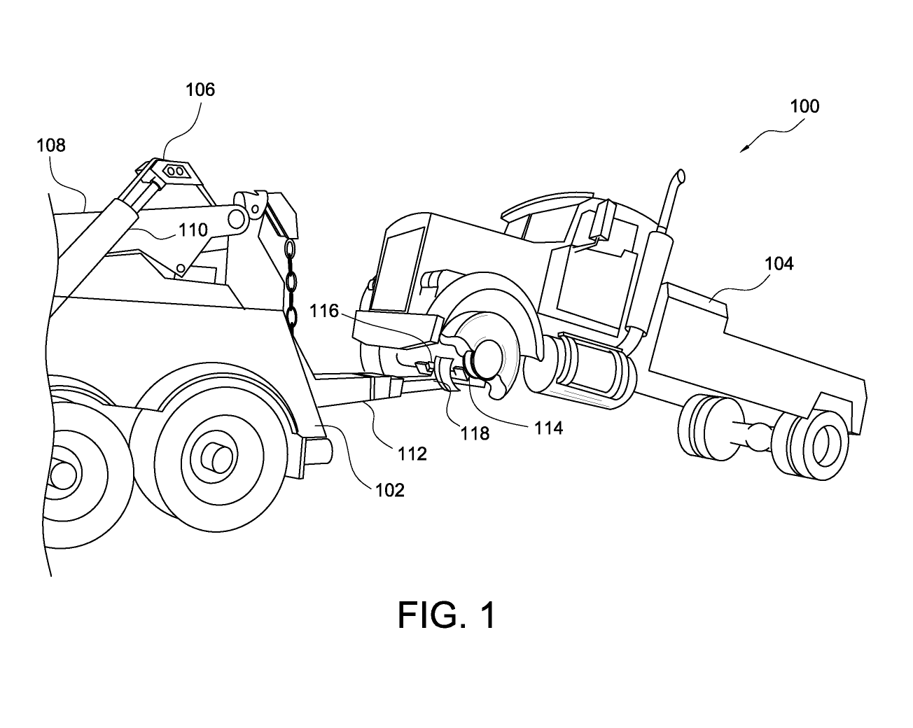

In particular, while a variety of ratchet machines have been previously prepared in respective configurations, some superficially similar to certain aspects of the instant invention, the present invention embodies a new understanding of important and surprising trade-offs made in actuator design, particularly where the ratchet machine is to be employed in a confined space. Such confined applications are exemplified by the use of a ratchet machine in securing a towing apparatus coupling two vehicles such that a first vehicle is arranged to tow a second vehicle. An exemplary configuration of this sort is shown in FIG. 1.

FIG. 1 illustrates an exemplary towing arrangement 100 in which a first tow truck 102 is coupled to a second vehicle 104, being towed. In the illustrated arrangement, the tow truck 102 includes a hydraulic lift apparatus 106 having a pivoting boom 108 arranged to be elevated by hydraulic cylinder actuators, e.g. 110. The pivoting boom 108, in turn, elevates an extension boom 112. Extension boom 112 is coupled to and supports an under-axle lift member 114 which supports the axle and/or frame 116 of the second vehicle 104. Coupling apparatus 118 is typically applied in order to ensure that the second vehicle 104 remains securely attached to the under-axle lift member 114.

The process of installing the coupling apparatus 118 often takes place under less than ideal conditions and, consequently, can be difficult. For example, when the vehicle being towed has broken down en route to its destination, the coupling of the tow truck to the vehicle being towed will often take place on a roadside shoulder that may be unpaved, wet and/or muddy. When the towing takes place subsequent to a wreck, it may be necessary to attach the vehicles to one another in even less desirable circumstances such as, for example, in a ditch, on a median or in a field.

It is always advisable that the installation of coupling apparatus 118 be completed before any elevation of the vehicle being towed by the pivoting boom. Consequently, the workspace available for the personnel charged with installing the coupling apparatus 118 will be limited to, at best, the normal ground clearance of the vehicle being towed, and may be substantially less. For example, where the vehicle's tires have been flattened, or where the ground under the vehicle is uneven, installation clearance can be very constrained.

At the same time, it is important that installation of the coupling apparatus 118 be effective to retain the vehicle being towed in close connection with the under-axle lift member 114. This typically requires the application of substantial tension to a generally flexible member of the coupling apparatus.

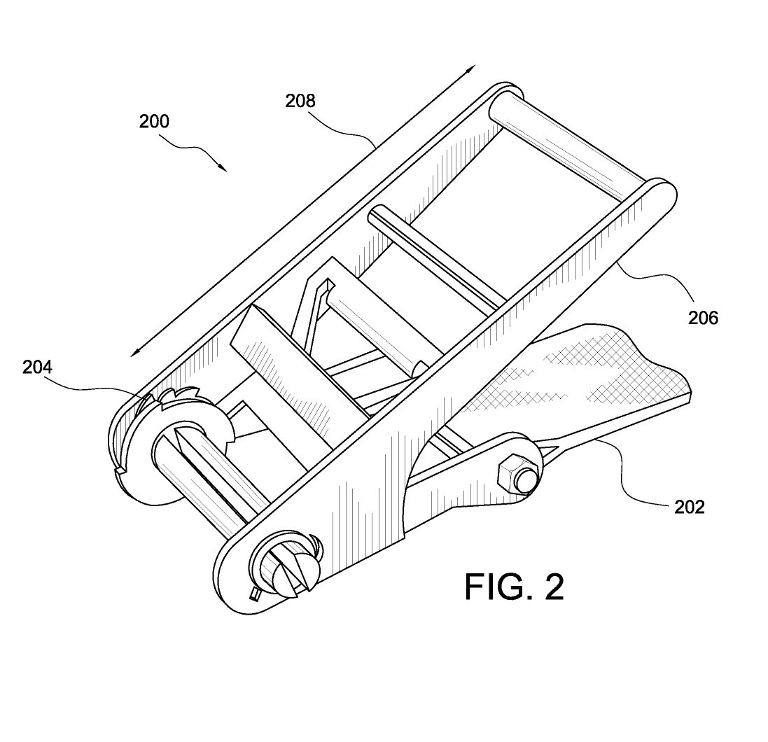

FIG. 2 shows a conventional ratchet machine 200 arranged to apply tension to a webbing member 202. A ratchet wheel 204 is actuated with a handle 206. One of skill in the art will appreciate that the forces available to tension the webbing member 202 will be limited by the strength of an operator, the overall strength of the apparatus and its components, and the length of the lever arm 208 afforded by handle 206. As a general rule, a longer lever arm 208 will allow higher tensile forces to be applied to the webbing member 202 and, consequently, result in a more secure coupling between the towing vehicle and the vehicle being towed.

As will be clear from the foregoing discussion, however, the space available to the user for operating the ratchet machine may be very limited. Consequently, the desirability of a long lever arm 208 for tensioning the webbing 202 runs contrary to the need to have the overall dimensions of the ratchet machine small so as to allow easy handling and operation within the constrained space of the installation environment. In conventional equipment, this dilemma is generally resolved in favor of a relatively short handle 206 and correspondingly short lever arm that limits the coupling effectiveness of the apparatus.

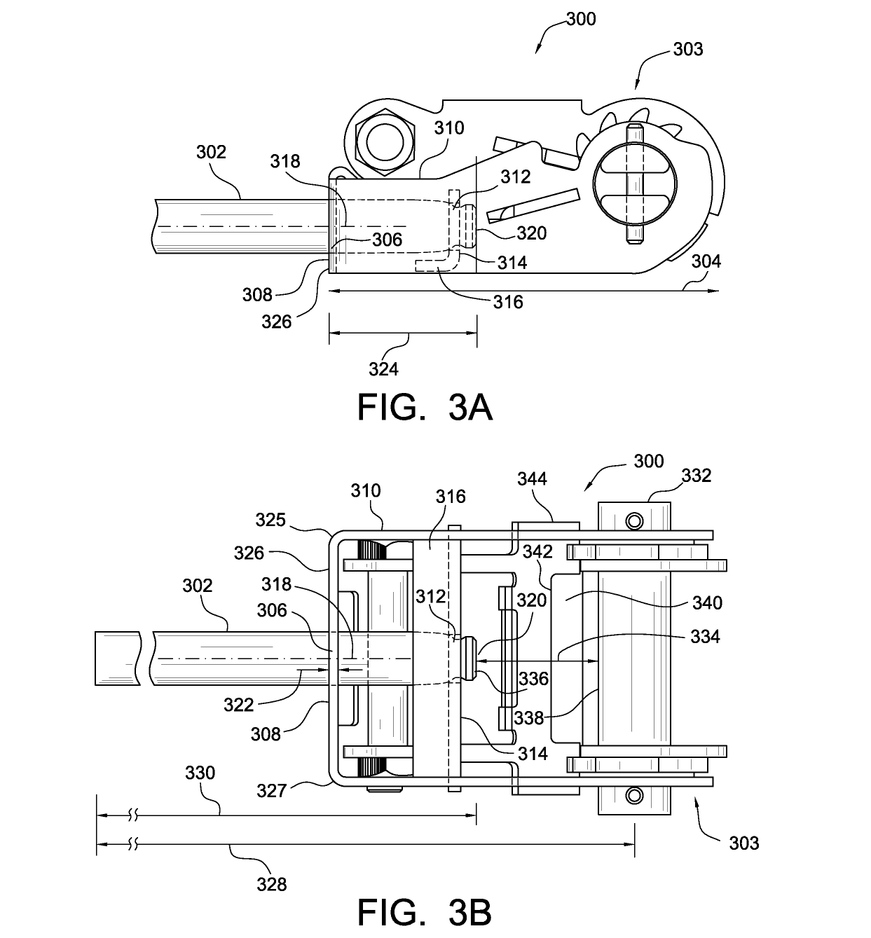

FIGS. 3a and 3b show certain aspects of a further conventional ratchet machine 300 where a removable handle 302 is implemented to allow the application of relatively high lever forces to a machine having relatively small overall dimensions, e.g., 304. FIG. 3a shows the ratchet machine in side view and FIG. 3b shows the same machine in top view. From inspection of FIGS. 3a and 3b it is apparent that handle 302 is coupled to the balance of the ratchet machine 303 by being disposed within a first aperture 306 in a first region 308 of a frame portion 310 and within a second aperture 312 in a second region 314 of a crossmember 316. It will be noted that in the illustrated device, the handle 302 has a longitudinal axis 318 and a knob end 320 having a circular cross section.

After careful evaluation, the inventor has observed that the first aperture 306 has a length corresponding to a local thickness 322 of frame portion 310 at region 308. In the illustrated conventional device, this thickness is the thickness of a manufacturing blank which is deformed (i.e. bent) at first 325 and second 327 corners to form the corresponding frame portion 310. In order to facilitate the bending process, it is generally considered desirable that the overall thickness 322 of the manufacturing blank be optimized at a relatively small value. The resulting relatively short length of aperture 306 (i.e., equal to thickness 322) leads to the need for the presence of crossmember 316 so as to provide adequate support for the handle 302 during the tensioning process.

It will further be noted that, because the handle 302 is supported both at a first surface defining the first aperture 306 and at a second surface defining the second aperture 312, insertion of handle 302 into the ratchet device 300 requires two separate alignment actions. The knob end 320 of handle 302 must first be successfully inserted into aperture 306 and thereafter inserted into aperture 312. For this insertion to be repeatably effected within the constraints offered by a roadside environment, the size of aperture 306 must substantially exceed the corresponding cross-section of handle 302 and knob 320. This tolerance, however, will allow angular displacement of longitudinal axis 318 such that the further insertion of knob 320 into aperture 312 requires active alignment. The present inventor has observed that this two-step requirement makes the handle insertion process of the ratchet machine 300 unnecessarily difficult and time-consuming.

Further, once inserted within the second aperture 312, the length 324 of the handle that is disposed inwardly of the outer surface 326 of region 308 becomes ineffective for adding to the overall lever arm length 328 of the device. In other words, the constrained working environment must accommodate the full length 330 of the handle 302 prior to insertion, but after installation, the user does not gain the benefit of this full-length to improve leverage for operation of the ratchet machine.

In addition, it should be noted that the long insertion length 324 of the handle end 320 into the relatively short 304 body of the ratchet machine 300 requires the placement of crossmember 314 in relatively close proximity to a webbing reel 332. This leaves a limited distance 334 between the surface 336 of the knob end 320 and the facing peripheral surface 338 of the webbing reel 332. Within this limited region there is little space for a release handle of any sort. In the illustrated device, this deficiency appears to be addressed by requiring an operator to insert his or her fingers into a further aperture 340 that is defined between a forward surface 342 of a pawl member 344 and an outer surface of a webbing member (not shown) wrapped in tension around peripheral surface 338 of the webbing reel 332 in order to release the tensioned ratchet.

Recognizing that the webbing member will be subject to some thousands of pounds of force when in use, and that releasing the pawl member can result in an abrupt and immediate acceleration of the webbing with a corresponding rapid rotation of the webbing reel 332, one of skill in the art will readily appreciate the danger to a user's fingers entailed in performing such an action. Indeed, for a fully loaded reel, the outer surface of a user's fingers would be virtually in contact with the tensioned webbing when actuation of the pawl member 344 results in its explosive acceleration.

The device illustrated in FIGS. 3a and 3b corresponds to U.S. Pat. No. 4,510,651 which matured from an application filed more than 20 years ago in January of 1983. Consequently, it is clear that the need for a coupling device offering improved leverage for tensioning has been long felt within the marketplace. Nonetheless, it is only now, and in light of the creativity of the present inventor, that this need is successfully resolved in the form of the novel features and improvements presented in the instant application.

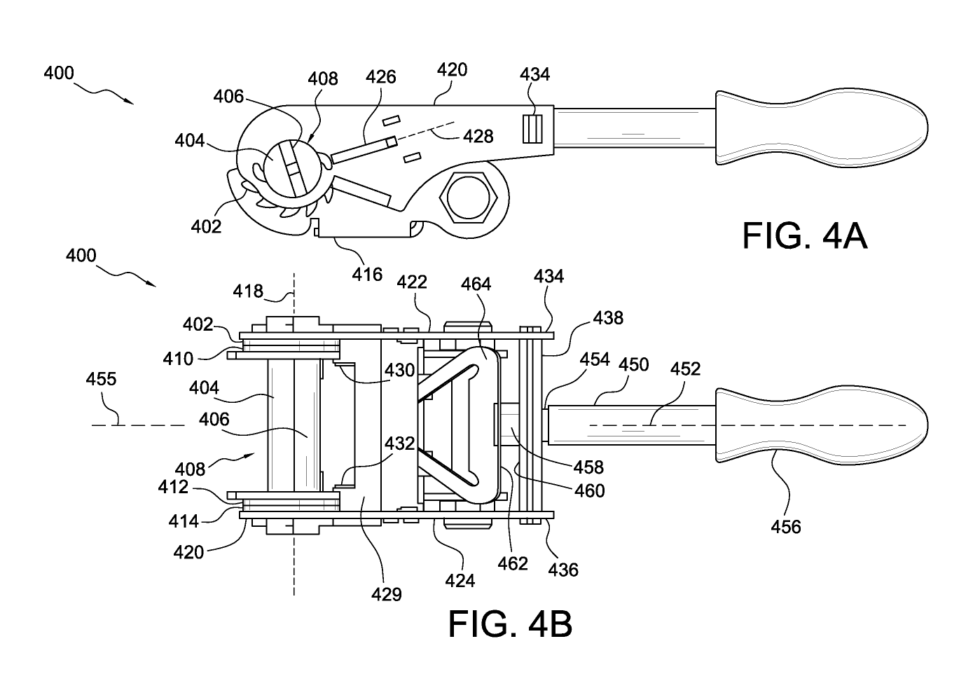

FIGS. 4a and 4b show certain aspects of a ratchet machine prepared according to principles of the invention. FIG. 4a shows the ratchet machine 400 in side view and FIG. 4b shows the same machine 400 in a corresponding top view. The ratchet machine includes a ratchet wheel 402. The ratchet wheel 402 is substantially fixedly coupled to first 404 and second 406 reel members to form a reel assembly 408. In various embodiments, and as illustrated here, the ratchet wheel may include a plurality of wheel plates e.g., 410, 412, 414.

The reel assembly is disposed within apertures in respective sides of a frame portion 416, where the apertures are defined by internal surface regions and such that the internal surface regions served to support the reel assembly for rotational motion around a longitudinal axis 418 thereof.

The ratchet machine includes an actuator assembly 420 that incorporates first 422 and second 424 side plates. The side plates have respective apertures within which are disposed respective portions of the reel assembly such that the actuator assembly is supported for reciprocating pivotal motion about longitudinal axis 418. The side plates 422, 424 also include respective slots e.g., 426. The slots are defined by respective inner surface regions of the side plates 422, 424 respectively. Each slot has a respective longitudinal axis e.g. 428 disposed generally normal to longitudinal axis 418.

The slots are arranged to receive respective portions of a first pawl plate 429 so that the internal surface regions defining the slots interface with corresponding surface regions of the pawl plate 429 to support the pawl plate for generally linear reciprocal motion, with respect to longitudinal axis 418, along longitudinal axis 428. One or more springs, not shown, are provided to urge the pawl plate 429 towards longitudinal axis 418 along axis 428.

The pawl plate 429 includes protruding portions 430, 432 arranged to slidingly interfere with respective teeth of the ratchet wheels respectively during operation of the actuator portion. One of skill in the art will understand that this interaction between pawl plate portions 430, 432 and the ratchet wheel serves to fix the actuator portion to the ratchet wheels for rotation of the ratchet wheels during an upward stroke of the actuator portion. Subsequently, during a downward stroke of the actuator portion, the actuator portion is rotationally disengaged from the ratchet wheels by a sliding cam action between the pawl portions 430, 432 and the ratchet wheel teeth.

In the illustrated embodiment, each side plate 422, 424 includes a further respective aperture 434, 436 defined by respective internal surface regions of the corresponding side plate. Disposed within these apertures 434, 436 are respective portions of a receiving member 438. The receiving member 438 is, in certain embodiments, substantially rigidly coupled to the side plates so as to provide strength and rigidity to the actuator assembly 420.

In various apparatus prepared according to principles of the invention, the receiving member 438 is substantially fixedly coupled to the side plates 422, 424 by a forging or peening operation. In other embodiments of the invention, receiving member 438 is substantially fixedly coupled to the side plates 422, 424 by an electrical welding operation. In still other embodiments of the invention, receiving member 438 is substantially fixedly coupled to the side plates 422, 424 by a gas welding operation, a laser welding operation, an electron beam welding operation, an ultrasonic welding operation, or any other welding operation such as is known or becomes known to those of skill in the art.

In still further embodiments of the invention, receiving member 438 is substantially fixedly coupled to the side plates 422, 424 by the use of a mechanical fastener such as a screw, a rivet, a cotter pin, or any other mechanical fastener such as is known or becomes known to those of skill in the art. In yet further embodiments of the invention, receiving member 438 is substantially fixedly coupled to the side plates 422, 424 by the use of adhesive or other chemical means. In still further embodiments of the invention, the side plates and receiving member are formed in integral fashion by, for example, molding, forging, 3-D printing, particulate sintering, mechanical machining from bulk stock, laser machining, or any other mechanical process or method such as is known or becomes known to those of skill in the art.

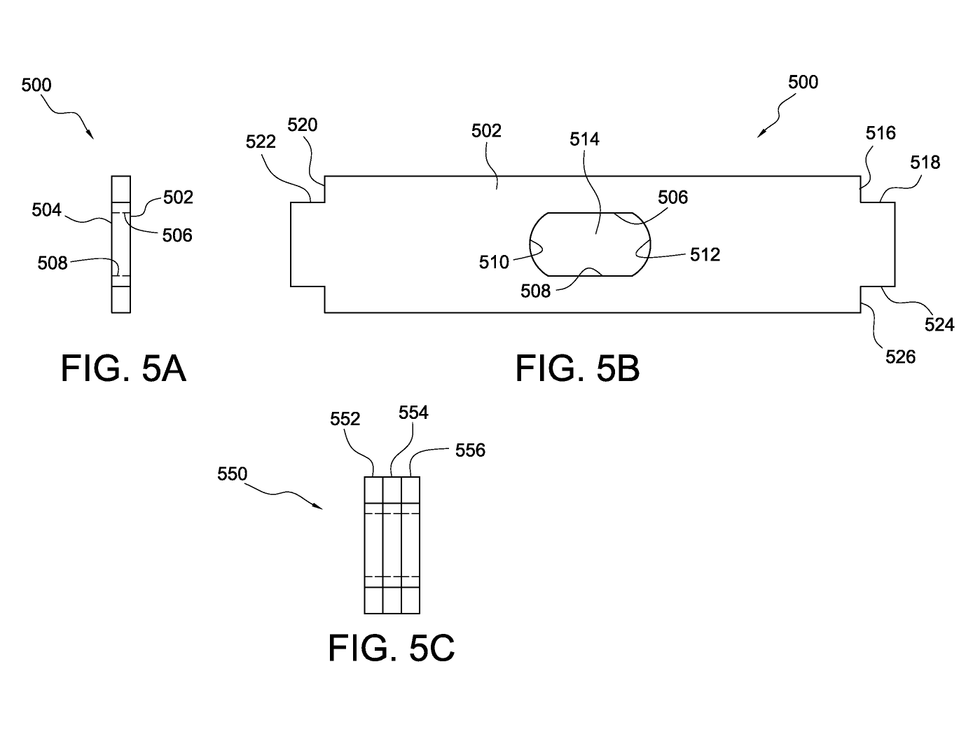

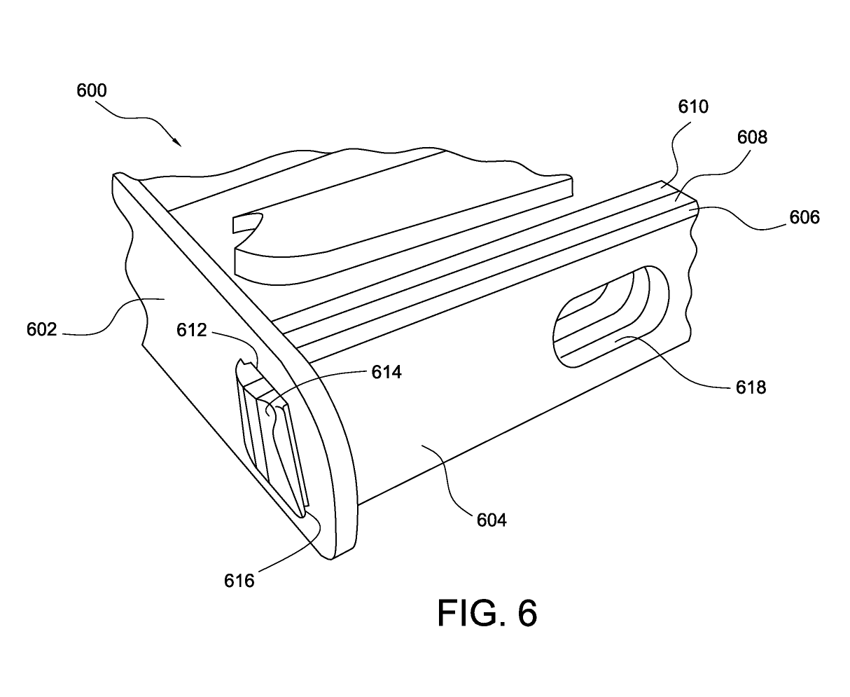

Referring now to FIGS. 5a and 5b, one sees a portion of an exemplary receiving member 500 similar to receiving member 438. FIG. 5a shows receiving member 500 in end view and FIG. 5b shows the same member 500 in a side view. In the illustrated embodiment, the receiving member portion has first 502 and second 504 substantially planar surface regions disposed in substantially parallel space relation to one another.

Internal surface regions e.g., 506, 508, 510, 512 define an aperture 514 for receiving a distal end of a handle. The illustrated embodiment shows one aspect of the invention in which aperture 514 has a peripheral edge generally in the form of a racing oval (i.e., a flattened or truncated ellipse). Apertures of various peripheral shapes are beneficial in surprising and unexpected ways in the context of the present invention. Thus, for example, in various embodiments, the invention will include an aperture having a peripheral edge that is rectangular, square, triangular, pentagonal, hexagonal, heptagonal, stellate, purely elliptical, semicircular, quarter-round, “V” shaped, or any other geometric shape appropriate to a particular application, and a corresponding portion of the handle will have a similar cross-sectional shape.

Further surface regions e.g., 516, 518, 520, 522, 524, 526 define notches at each corner, respectively, of the illustrated receiving member portion 500. The notches provide shoulders arranged to butt against respective inner surfaces of the corresponding side plate so as to effectively locate the receiving member portion vis-à-vis the side plate, and thus define and strengthen the actuating assembly.

FIG. 5c shows an aggregation 550 of three receiving member portions 552, 554, 556 like those shown 500 in FIG. 5a. In light of the current presentation, one of skill in the art will appreciate the benefits in terms of structural strength and rigidity of disposing multiple receiving member portions in parallel to prepare a receiving member of appropriate characteristics.

This relationship is further evident in, for example, the perspective view offered by FIG. 6, which shows, in additional detail, a portion of a ratchet machine 600 prepared according to principles of the invention. Visible in FIG. 6 is a portion of a side plate 602 and a receiving member 604. In the illustrated embodiment, the receiving member 604 is composed of several receiving member portions (here, three) 606, 608 and 610. The receiving member portions 606, 608, 610 are disposed adjacent one another and their respective end portions are disposed within and through aperture 612 of the side plate 602.

As illustrated, the ends of the receiving member portion 606, 608 and 610 show deformation, e.g., 614, 616 where they have been distorted by forging, peening, or a similar process. Consequently, the material of the receiving member portions has expanded within aperture 612, effectively locking the receiving member portions 606, 608, 610 into a substantially fixed and integrated relationship with the side plate 602. As discussed above a variety of alternative fastening methods can be used to achieve similar ends in other embodiments of the invention.

The fixed relationship of the receiving member portions 606, 608, 610 and the side plate 602, as well as the strength and rigidity characteristics of the receiving members ensures that forces applied to a handle inserted into aperture 618 will be effectively transferred through the receiving member 604 to the side plates e.g., 602, and the balance, of the actuating assembly.

Referring again to FIGS. 4a and 4b, in the illustrated embodiment, insertion of a handle 450 into receiving member 438 tends to align a longitudinal axis 452 of the handle with a corresponding longitudinal axis 455 of the ratchet machine. The illustrated handle includes an inner substantially rigid core 454 and an external portion 456 shaped, e.g., to be readily gripped by a user.

A distal end portion 458 of the inner core 454 extends a short distance beyond an inward-facing surface region 460 of the receiving member 438. However, this portion 458 does not extend far enough to interfere with a proximal edge 462 of a release handle 464 disposed within the ratchet machine. The release handle 464 is coupled to, or integral with, the pawl plate 429 and allows the protruding portions 430, 432 of the pawl plate 429 to be disengaged from the ratchet wheels when desired. Accordingly, the relatively short length of distal end portion 458 allows certain devices prepared according to principles of the invention to accommodate a release handle. Such a release handle permits a relatively safe release of webbing tension and avoids the above-noted dangers of alternative arrangements.

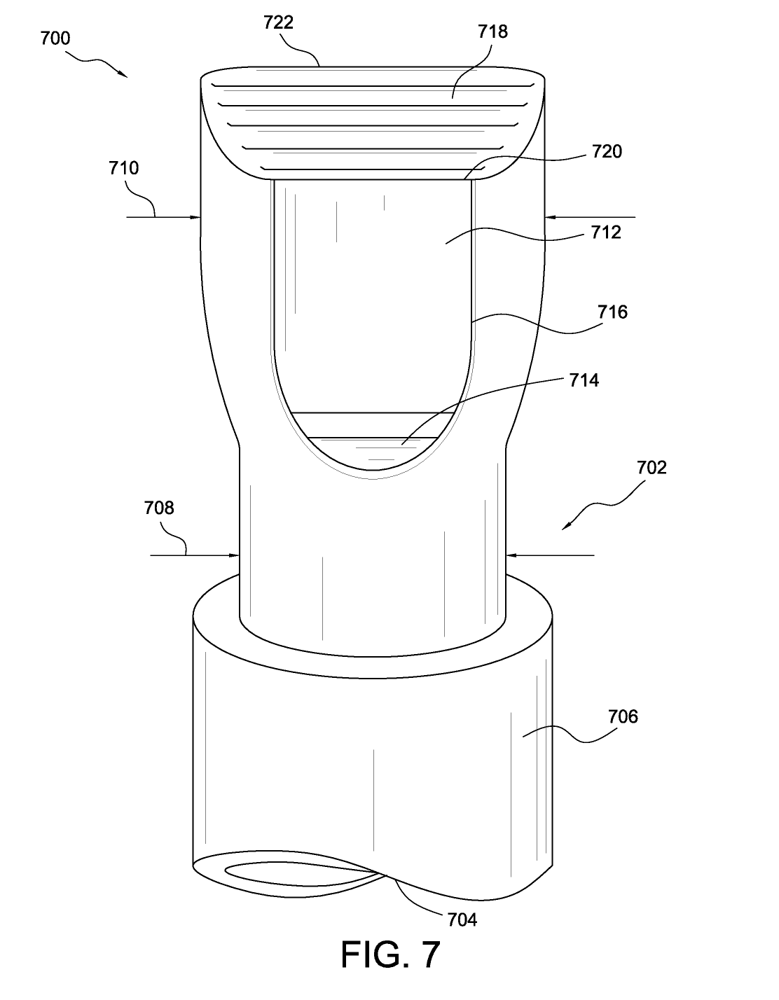

FIG. 7 shows, in schematic perspective view, additional detail of one distal end portion 700 of a handle 702 prepared according to principles of the invention. As illustrated, the handle includes a substantially rigid inner core 704 and an external portion 706 coupled thereto. The illustrated inner core 704 has a generally circular cross-section of a first diameter 708. It will be understood, however, that a wide variety of other cross-sectional forms will be appropriate to particular applications and will fall within the scope of the invention.

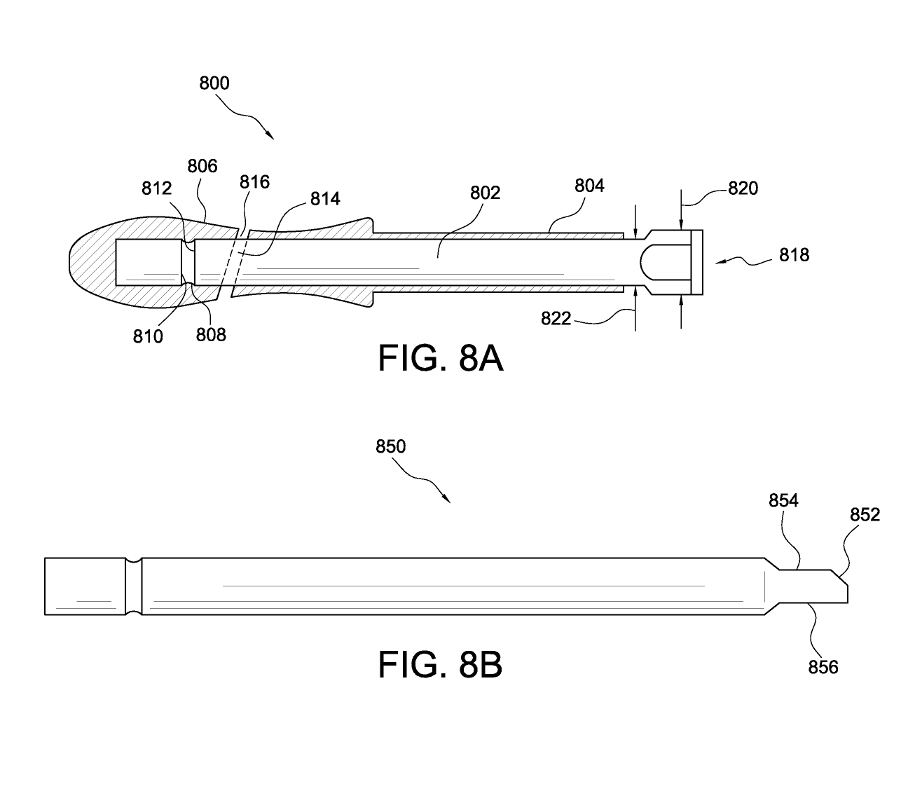

In the vicinity of the distal end portion 700, the cross-section of the handle 702 is generally flatter (i.e. more ellipsoid) and has a wider first dimension 710 as compared with diameter 708. One surface region of the end portion 700 is relieved to define a generally planar region 712 bordered at one end by a sloped portion 714, all within an ellipsoid edge 716. At the opposite end of the generally planar region from the sloped portion 714 is a further generally planar region 718 tapering between a generally linear border 720 with generally planar region 712 and a distal edge 722 of the handle 702. The configuration of this particular embodiment is further illuminated by FIGS. 8a and 8b which show portions of the same, or a similar, handle in a cross-sectional top view and a side view, respectively.

Referring first to the cross-sectional top view of a handle 800, one sees a substantially rigid inner core portion 802, surrounded by an external portion 804. The outer portion 804 includes a surface region 806 configured to be readily gripped by a human hand. A groove feature 808 present in the inner core portion 802 includes first 810 and second 812 shoulder surface regions that receive corresponding portions of the outer portion 804 (during, for example, an insert injection molding process) and consequently resist any tendency of the substantially rigid inner core portion 802 to slide longitudinally with respect to the outer portion 804.

The substantially rigid inner core portion 802 includes a further transverse bore feature 814 that is adapted to be aligned with a corresponding bore feature 816 of the outer portion 804. The aligned bores are arranged and adapted to mutually receive a fastener (not shown) such as, for example and without limitation, a roll pin or rivet. This fastener serves to further reduce any tendency of the outer and inner portions to shift with respect to one another under either or both of longitudinal and circumferential forces.

Further, a widening of the distal end 818 of the inner core portion 802 is apparent when one compares a width 820 of the adjacent material with a corresponding diameter 822 of the balance of the inner core portion 802.

FIG. 8b shows a core portion 850, like core portion 802, in side view. In this view one can clearly see the configuration of the generally planar surface regions 852, 854 and 856 which provide a tapered aspect to the distal end of the core portion 802. This arrangement facilitates the insertion of the handle into a corresponding aperture in a receiving member, and forms substantial bearing surfaces for transferring forces between the handle and the actuator portion of a ratchet machine prepared according to principles of the invention.

In a typical embodiment, the internal core portion 802 will include, for example, a metallic material such as steel, anodized steel, chrome plated steel, or the like. The outer portion 804 will include a material such as a synthetic polymer material. For example, the outer portion 804 may include a polyurethane material and further include a reflective, highly reflective and/or fluorescent and/or phosphorescent coloring material to increase visibility of the handle when used under adverse conditions. In certain embodiments, the coloring material will be a fluorescent orange coloring material. In other embodiments, the coloring material will be a fluorescent yellow coloring material.

Further, outer portion 804 may include an active lighting device such as, for example, an energy source and a light source. Thus, for example, outer portion 804 may include a light emitting diode, any necessary power control device known in the art, and a power storage device such as a chemical battery and/or a capacitive device. In certain embodiments, this power storage device may be recharged by the use of a generating device such as a piezoelectric generator and/or an electro-mechanical generator, whereby normal movement or active shaking of the handle will recharge the power storage device.

One of skill in the art will appreciate, that other materials will be appropriate to various applications of the present invention and accordingly fall within the scope of the invention as here disclosed. For example, the handle, ratchet machine and webbing will, in various embodiments, include one or more of metal or metallic alloys such as, e.g., stainless steel; aluminum; and an alloy such as Ni/Ti alloy. In addition, further materials found in various embodiments of the invention include polyethylene, polypropylene, polybutylene, polystyrene, polyester, acrylic polymers, polyvinylchloride, polyamide, or polyetherimide like ULTEM™; a polymeric alloy such as Xenoy™ resin, which is a composite of polycarbonate and polybutyleneterephthalate or Lexan™ plastic, which is a copolymer of polycarbonate and isophthalate terephthalate resorcinol resin (all available from GE Plastics), liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the contents of which are incorporated herein by reference), and/or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used. For example, a blend of polycarbonate and ABS (Acrylonitrile Butadiene Styrene) may be used.

Elastomers that may be used in various embodiments of the invention include various copolymers or block copolymers (Kratons®) available from Kraton Polymers such as styrene-butadiene rubber or styrene-isoprene rubber, EPDM (ethylene propylene diene monomer) rubber, nitrile (acrylonitrile butadiene) rubber, polyurethane, polybutadiene, polyisobutylene, neoprene, natural latex rubber and the like. Foam materials may be closed cell foams or open cell foams, and may include, but is not limited to, a polyolefin foam such as a polyethylene foam, a polypropylene foam, and a polybutylene foam; a polystyrene foam; a polyurethane foam; any elastomeric foam made from any elastomeric or rubber material mentioned above; or any biodegradable or biocompostable polyesters such as a polylactic acid resin (comprising L-lactic acid and D-lactic acid) and polyglycolic acid (PGA); polyhydroxyvalerate/hydroxybutyrate resin (PHBV) (copolymer of 3-hydroxy butyric acid and 3-hydroxy pentanoic acid (3-hydroxy valeric acid) and polyhydroxyalkanoate (PHA) copolymers; and polyester/urethane resin. One of skill in the art will appreciate that the foregoing are merely exemplary of a wide variety of possibilities that would be applied in an appropriate applications.

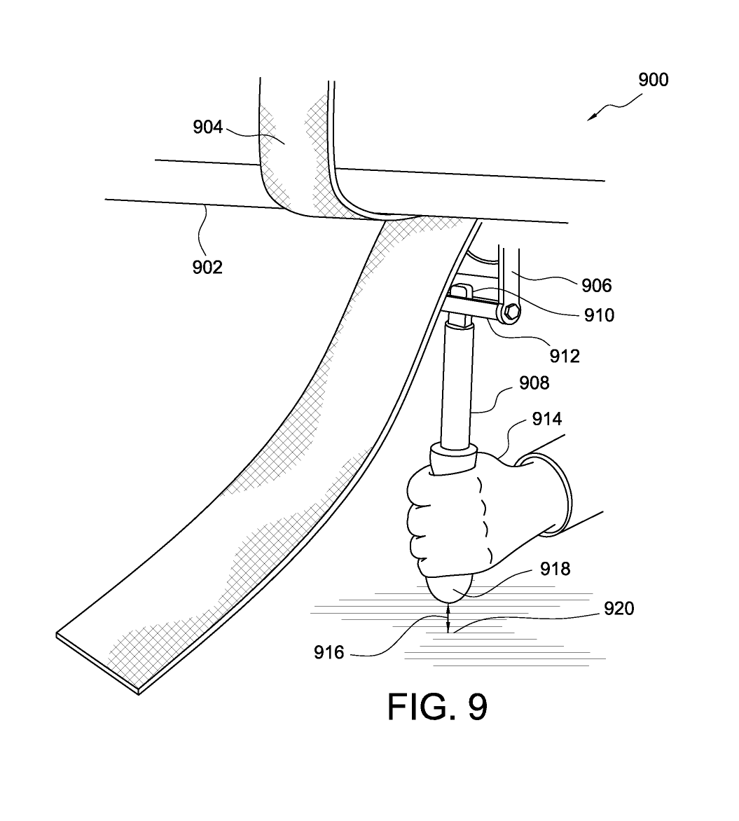

FIG. 9 shows, in schematic perspective view, an exemplary embodiment of the invention in use 900 and thus illustrates certain features of the invention and of a method of using the same. Featured in the illustration are a lifting beam of a towing vehicle 902 and a webbing or other tensile member 904 being applied to bind a vehicle to the lifting beam. Part of an actuating portion 906 of a ratchet machine is visible, and is shown coupled to a removable handle 908 by the insertion of a distal end 910 of the handle 908 into an aperture of a receiving member 912. Also illustrated is a method of grasping, inserting and actuating the device by an operator 914 using the removable handle 908.

Because only a short portion of the distal end 910 of the removable handle 908 is inserted into the receiving member 912, the handle can be removed from the receiving member and actuator portion even in the illustrated position with only a minimum of clearance 916 between a proximal end 918 of handle 908 and an underlying surface 920 such as a roadway, shoulder, or other feature.

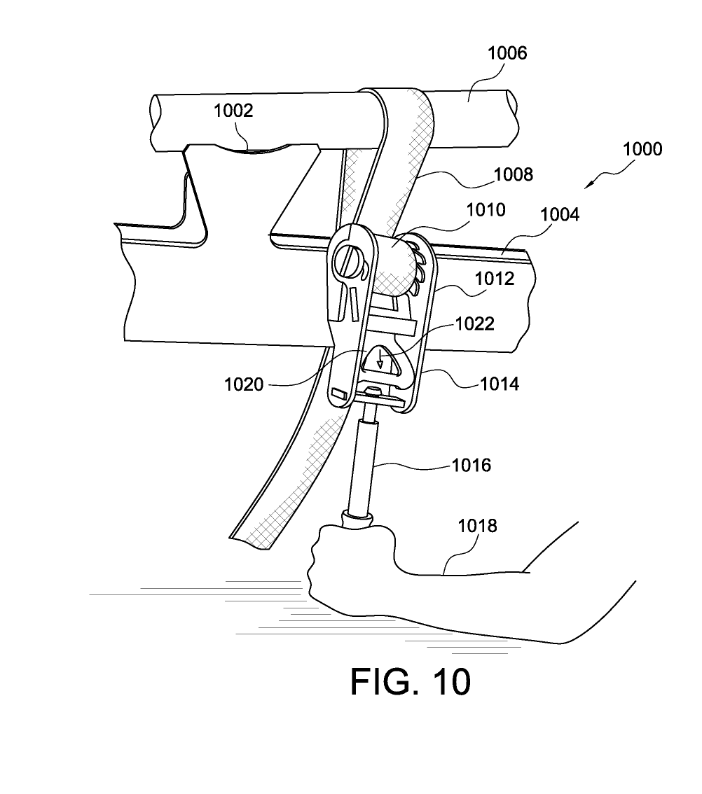

FIG. 10 shows, in schematic perspective view, a further aspect 1000 of an application of a ratchet machine assembly according to principles of the invention. In the illustrated arrangement, a contact surface 1002 of a lifting member 1004 has been moved into contact with an axle 1006 of a vehicle to be towed. A webbing portion 1008 has been passed around both the lifting member and the axle 1006 and threaded into the reel assembly 1010 of the ratchet machine 1012. Reciprocation of the actuator portion 1014 of the ratchet machine 1012, with or without the use of removable handle 1016, has caused the webbing to wrap securely around the reel assembly 1010. Thereafter, using the removable handle 1016, an operator 1018 is able to apply substantial tensile forces to the webbing 1008, thereby effectively securing the axle 1006 to the lifting member 1004.

When the operator is ready to release the axle 1006 from the lifting member 1004, he can, in conjunction with known actions, safely draw the release handle 1020 away from the ratchet wheel in the indicated direction 1022, thereby allowing the reel to turn freely and release the tension on the webbing 1008.

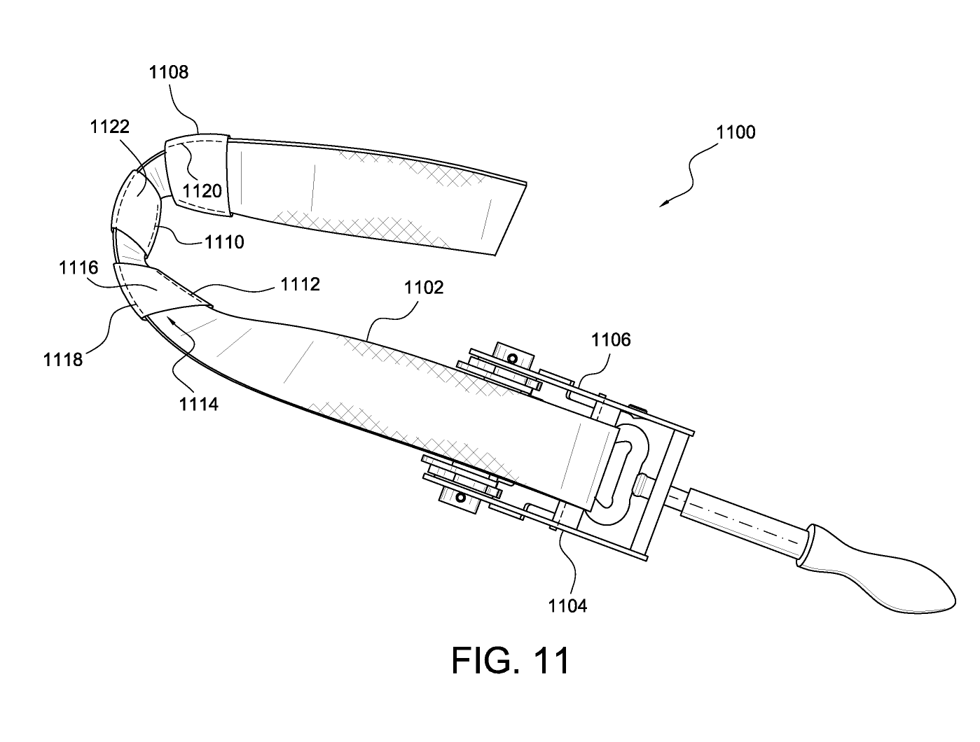

FIG. 11 shows a further aspect of the invention in which a ratchet machine 1100 prepared according to principles of the invention includes a substantially flexible generally inelastic webbing member 1102 coupled to a mounting bolt and nut combination 1104 of the ratchet machine base portion 1106. One or more reinforcing webbing protector devices, e.g., 1108, 1110, 1112 are slidably coupled to the webbing member 1102. For example, and as illustrated, in certain embodiments the webbing protector devices have a longitudinal aperture 1114 e.g., therethrough, and a portion of the webbing member 1102 is disposed within the aperture.

In certain embodiments, the webbing protector devices are prepared by sewing a respective upper portion 1116 to a respective lower portion 1118 with stitches 1120, where the upper and lower portions include a material (e.g. one or more of woven polyamide threads, woven polyaramid threads, etc.) similar to a material of which the webbing member 1102 is formed. In certain embodiments of the invention, a high visibility material 1122 is disposed on, or integrated into, one or more surfaces of the webbing protector. The high visibility material will include, without limitation, one or more of a reflective material, a fluorescent material and a phosphorescent material.

According to a method of using the device of the invention, one or more of the webbing protector devices is moved slidingly along the webbing and disposed between the webbing and a part being bound. Thus, for example, a portion of a webbing protector will be disposed between the webbing and an axle of a vehicle being towed. In certain embodiments, the webbing protector will include a pleated feature to increase the thickness and slip resistance of the webbing protector.

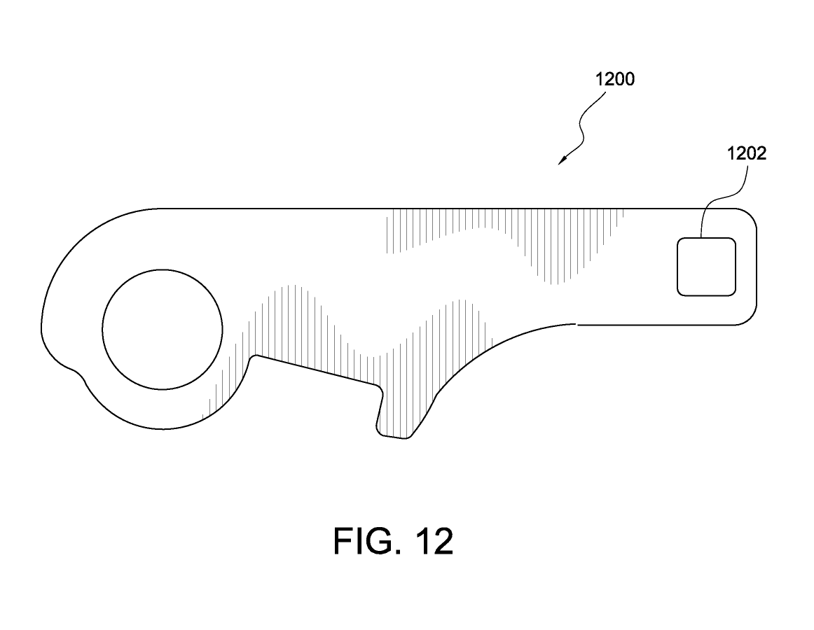

FIG. 12 shows, in further detail, an aspect of an actuator portion side plate 1200 of a ratchet machine prepared according to principles of the invention. As discussed above, in certain embodiments, the actuator portion side plate 1200 will include an aperture 1202 adapted to have a portion of a receiving member disposed there within. In the illustrated side plate, the aperture is defined by a generally square peripheral edge. One of skill in the art will appreciate, however, that a variety of other geometric forms will be beneficially employed in various embodiments of the invention. Accordingly, in certain embodiments of the invention, such a peripheral form will include a generally rectangular aspect, an elliptical aspect, a triangular aspect, a stellate aspect, a pentagonal aspect, a hexagonal aspect, or any other form which tends to secure the side plate and receiving member against undesirable rotational motion of the receiving member and that is otherwise beneficial for coupling the side plate and receiving member.

Likewise, while the receiving member exemplified above exhibits a generally square cross-section formed of a plurality of plates of generally rectangular cross-section, a variety of other cross-sections are also contemplated to be within the scope of the invention. Thus, for example, a receiving member may have a generally rectangular cross-section, an elliptical cross-section, a triangular cross-section, a stellate cross-section, a pentagonal cross-section, a hexagonal cross-section, or any other cross-section over its entire length, or over a portion of its length such as, for example, an end portion and/or a center portion.

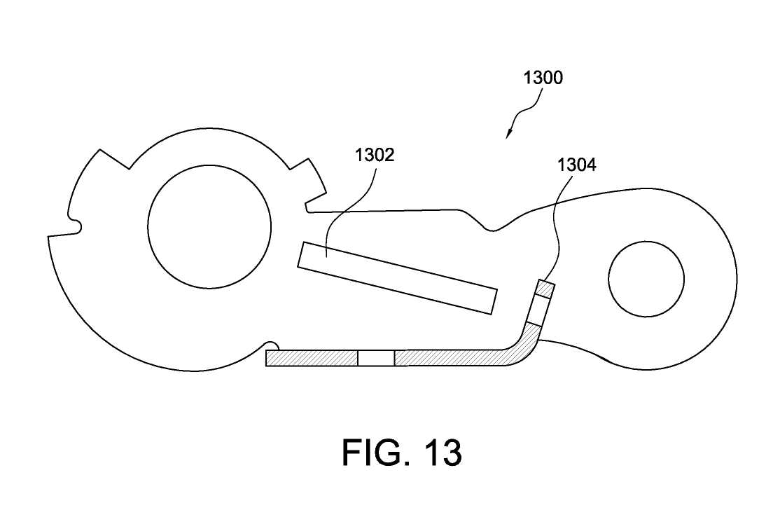

FIG. 13 shows, in schematic cross-section, a part of an exemplary ratchet machine base portion 1300 prepared according to principles of the invention. The base portion includes a slot-form aperture 1302 adapted to receive a portion of a pawl plate for sliding motion, as described above. The base portion also includes a flange portion 1304 adapted to support a spring (not shown), the spring being configured to urge the pawl plate towards a webbing reel (also not shown).

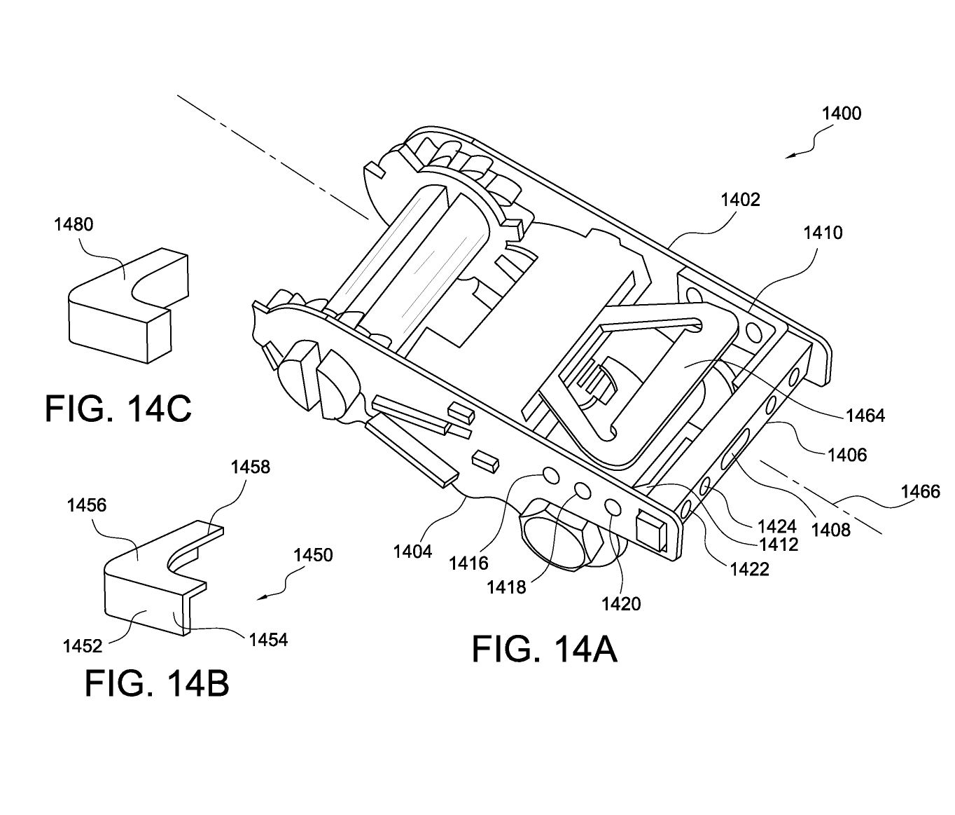

FIG. 14A shows in schematic perspective view further aspects of binding apparatus 1400 prepared according to principles of the invention. The binding apparatus includes, among other features, first 1402 and second 1404 side plates, and a receiving member 1406. The receiving member 1406 includes an aperture 1408 adapted (i.e., arranged and configured) to receive a distal end of a handle (not shown).

Binding apparatus 1400 also includes first 1410 and second 1412 reinforcing gussets coupled to the binding apparatus 1400, as shown. The reinforcing gussets have respective supporting surface regions disposed adjacent to corresponding surface regions of the side plates and receiving member respectively so that an inherent rigidity of the supporting gusset is imparted to the interface between the side plates 1402, 1404 and the receiving member 1406, and imparted to the apparatus as a whole.

In the illustrated embodiment, exemplary fastener devices 1416, 1418, 1420, 1422 and 1424 are shown for operatively coupling the supporting gusset 1412 to the side plate 1404 and receiving member 1406. One or more of the fastener devices will, in certain embodiments, include a nut and a bolt. In other embodiments, the fastener devices will further include respective lock washers. In still other embodiments the fastener devices will include one or more rivets.

In a particular embodiment, three nut and bolt combinations will be used a couple each supporting gusset to a respective side plate of the binding apparatus 1400. Two nut and bolt combinations will be used to couple each supporting gusset to a respective receiving member 1406. In other embodiments, different numbers or combinations of fastener devices will be employed according to the requirements of a particular application. For example, two nut and bolt combinations will be used to couple a gusset to a side plate in a certain application.

In further embodiments, one or more fastener devices will be omitted, and the gussets will be coupled to the sides 1402, 1404 and receiving member 1406 by other means such as, for example, electrical weldment, gas weldment, laser weldment, a chemical release, or by any other technique known or that becomes known in the art.

As illustrated in FIG. 14A, the exemplary supporting gusset 1410 is a simple L-shaped bracket. FIG. 14B shows an alternative configuration for a supporting gusset 1450. In the alternative configuration 1450, the supporting gusset includes a generally L-shaped surface region 1452 with a first portion 1454 configured to be coupled adjacent to a side plate and a second portion (not visible) configured to be coupled adjacent to a receiving member. In addition, the supporting gusset 1450 includes a further portion 1456 having a surface region disposed generally perpendicular to both the first and second portions of surface region 1452. As will be readily appreciated by one of skill in the art, the further portion 1456 serves to add strength and rigidity to the supporting gusset 1450.

Supporting gusset 1450 is shown to be formed of a relatively thin material such as, for example, a stamped and/or welded sheet metal material. One of skill in the art will appreciate that alternative supporting gussets will be formed by, for example, molding and/or powder metallurgy techniques. In still further embodiments, the supporting gussets will include plural reinforcing flanges and/or a solid body like that shown 1480 in FIG. 14C.

Referring again to FIG. 14B, in the illustrated configuration, portion 1456 includes a generally arcuate edge 1458. Edge 1458 is configured and arranged to allow clearance for normal operation of a release handle 1464 (as shown in FIG. 14A). While the illustrated edge 1458 is generally arcuate, one of skill the art will appreciate that other configurations including various piecewise linear and piecewise arcuate edges will also be beneficially employed in appropriate circumstances.

One of skill in the art will appreciate that the indicated exemplary supporting gussets will generally provide additional rigidity to the overall structure of the binding apparatus 1400 so as to reduce or substantially eliminate twisting and flexing along and about a longitudinal axis 1466 (as shown in FIG. 14A).

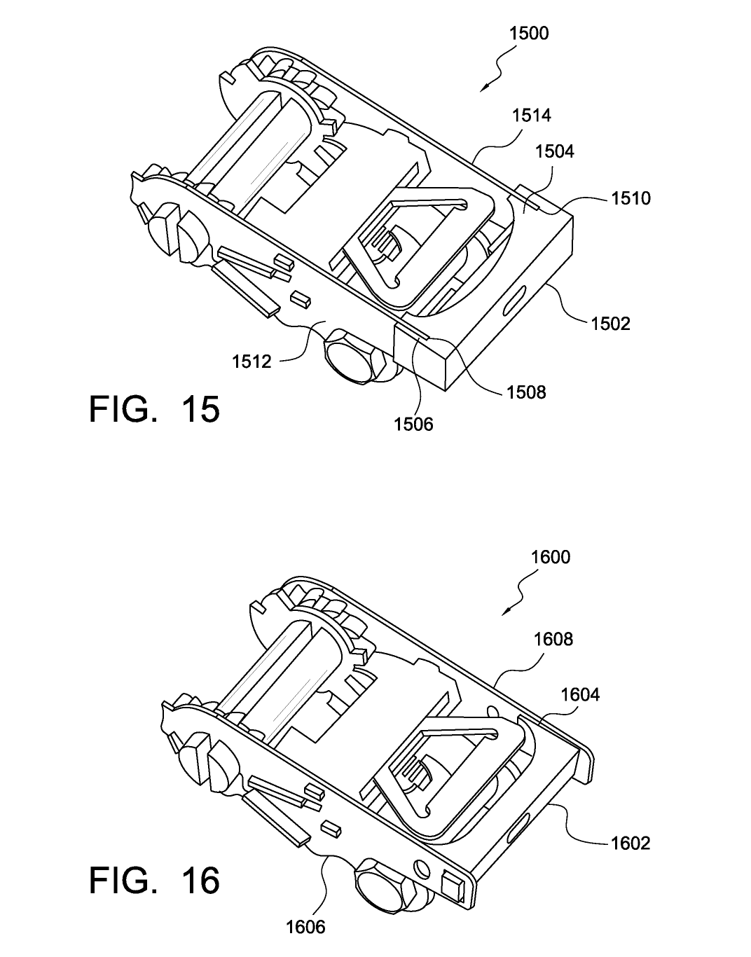

FIG. 15 shows certain further aspects and features of a binding apparatus 1500 prepared according to principles of the invention. Among these aspects is a receiving member 1502 including generally integral supporting gusset portions 1504, 1506. In the illustrated example, the integral supporting gusset portions 1504, 1506 include respective slots 1508, 1510 into which are received corresponding regions of side plates 1512, 1514 respectively.

As shown in FIG. 15, an exemplary receiving member 1502 will be formed as an integral unit by, for example molding, injection molding, die casting, drop forging, powder metallurgy techniques, or any other appropriate technique. Moreover the receiving member 1502 will include any metallic or other material appropriate to a particular application such as is known or may become known in the art.

As shown in FIG. 16 a further exemplary receiving member 1602 of a binding apparatus 1600 will be formed without slots, but coupled to corresponding surface regions e.g., 1604 respectively of side plates 1606, 1608.

While the exemplary embodiments described above have been chosen primarily from the field of vehicle towing, one of skill in the art will appreciate that the principles of the invention are equally well applied, and that the benefits of the present invention are equally well realized in a wide variety of other binding applications including, for example, load binding within a vehicle, temporary building assembly activities, shipbuilding, farming, and a plethora of other applications.

Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A ratchet machine comprising:
a receiving member, said receiving member being adapted to receive a distal end of a removable actuation handle within an aperture thereof, said aperture being defined by a supporting surface region, the supporting surface region being adapted to fully support a mechanical interaction between said ratchet machine and said removable actuation handle.

2. A ratchet machine as defined in claim 1 wherein said receiving member comprises a plurality of substantially rigid plates.

3. A ratchet machine as defined in claim 1 wherein said receiving member is coupled to corresponding regions of first and second side plates of said ratchet machine by respective deformed portions of said receiving member.

4. A ratchet machine as defined in claim 1 wherein said supporting surface region includes at least a first substantially planar portion.

5. A ratchet machine as defined in claim 1 further comprising a supporting gusset disposed to reinforce an interface between said receiving member and a side plate of said ratchet machine.

6. A ratchet machine as defined in claim 5 wherein said supporting gusset is coupled to said side plate by a mechanical fastener.

7. A ratchet machine as defined in claim 1 wherein said receiving member is integrally formed to include a supporting gusset portion, said supporting gusset portion including a further surface region disposed in close proximity to a side plate of said ratchet machine.

8. A ratchet machine as defined in claim 1 wherein said removable handle includes a first substantially rigid shaft portion and a second gripping portion, said gripping portion including a gripping surface region configured for effective manipulation by a user.

9. A ratchet machine as defined in claim 9 wherein said second gripping portion includes a relatively thermally insulating material as compared to said shaft portion.

10. A ratchet machine as defined in claim 9 wherein said second gripping portion includes a high visibility material.

11. A method of operating a ratchet machine comprising:
providing said ratchet machine with a receiving member and a spool;
uniquely coupling a distal portion of a discrete handle to said receiving member of said ratchet machine so that a mechanical interface between said discrete handle and said ratchet machine is fully supported by said receiving member; and
oscillating said discrete handle to effect a rotation of said spool.

12. A method of operating a ratchet machine as defined in claim 11 wherein a portion of a lateral force applied to said discrete handle is effectively coupled from said discrete handle to a side plate of said ratchet machine through a discrete supporting gusset.

13. A method of operating a ratchet machine as defined in claim 11 wherein a portion of a lateral force applied to said discrete handle is effectively coupled from said discrete handle to a side plate of said ratchet machine through an integrated supporting gusset portion of said receiving member.

14. A method of operating a ratchet machine as defined in claim 11 wherein said coupling of the distal portion of said discrete handle comprises inserting said distal portion of said discrete handle into a corresponding aperture within said receiving member, said aperture being defined by an internal circumferential surface region.

15. A method of operating a ratchet machine as defined in claim 14 wherein said internal circumferential surface region comprises at least one substantially planar portion.

16. A method of transferring an operative force from a discrete operating handle to a ratchet machine comprising:
coupling a distal end portion of said discrete operating handle to a unique receiving member of said ratchet machine; and
operating said ratchet machine in response to said operative force.

17. A method of transferring an operative force from a discrete operating handle to a ratchet machine as defined in claim 16 wherein said unique receiving member comprises a plurality of substantially rigid plates disposed directly or indirectly in contact with one another to form a single member.

18. A method of transferring an operative force from a discrete operating handle to a ratchet machine as defined in claim 16 wherein said unique receiving member comprises a single integrally formed beam.

19. A method of transferring an operative force from a discrete operating handle to a ratchet machine as defined in claim 16 further comprising transferring a portion of said force from said discrete operating handle to said receiving member and through a further supporting gusset to a side wall of said ratchet machine.

20. A method of transferring an operative force from a discrete operating handle to a ratchet machine as defined in claim 19 wherein said receiving member and said supporting gusset are integrally formed as a single unit.
